(19) United States
(12) Patent Application Publication
(10) Pub. No.: US 2008/0243581 A1
(43) Pub. Date: Oct. 2, 2008

(54) PERSONNEL MANAGEMENT METHOD AND SYSTEM

(76) Inventor: Derek M. Jennings, Wake Forest, NC (US)

Correspondence Address: SCHMEISER, OLSEN & WATTS, 22 CENTURY HILL DRIVE, SUITE 302, LATHAM, NY, 12110, US

(21) Appl. No.: 11/691,572

(22) Filed: Mar. 27, 2007

(51) Int. Cl. G06Q 10/00

(52) U.S. Cl. 705/9

(57) ABSTRACT

A personnel management method and system. The method includes receiving by a computing system, first data from a first resource in response to a first survey. The computing system receives second data in response to a second survey. The computing system analyzes the first data with respect to said second data. Based on the analyzing, the computing system generates a first resource specification report associated with a first resource and a project model. Based on the analyzing and the project model, the computing system generates a first project specification report.

### FIELD OF THE INVENTION

The present invention relates to a method and associated system for receiving information associated with a human resource from a variety of sources and mapping the resource to a specific project based on the information.

### BACKGROUND OF THE INVENTION

Selecting individuals to perform specified functions typically comprises a complicated and inefficient process with little flexibility. Accordingly, there exists a need in the art to overcome the deficiencies and limitations described herein above.

### SUMMARY OF THE INVENTION

The present invention provides a personnel management method comprising:

presenting to a first resource, by a computing system, a first survey comprising a first plurality of questions;

receiving, by said computing system, first data from said first resource in response to said first survey, said first data comprising first resource supplied information associated with: said first resource, a first management party associated with said first resource, and a first group of projects associated with said first resource;

presenting to said first management party, by said computing system, a second survey comprising a second plurality of questions;

receiving, by said computing system, second data from said first management party in response to said second survey, said second data comprising first management supplied information associated with said first resource, said first management party, and said first group of projects;

first analyzing, by said computing system, said first data with respect to said second data;

generating based on said first analyzing, by said computing system, a first resource specification report associated with said first resource;

generating based on said first analyzing, by said computing system, a first project model comprising first projected requirements for each project of said first group of projects; and

generating based on said first analyzing and said first project model, by said computing system, a first project specification report comprising first actual requirements for said first group of projects with respect to said first projected requirements for said first group of projects.

The present invention provides a computing system comprising a processor coupled to a computer-readable memory unit, said memory unit comprising instructions that when executed by the processor implement a personnel management method, said method comprising:

presenting to a first resource, by said computing system, a first survey comprising a first plurality of questions;

receiving, by said computing system, first data from said first resource in response to said first survey, said first data comprising first resource supplied information associated with: said first resource, a first management party associated with said first resource, and a first group of projects associated with said first resource;

presenting to said first management party, by said computing system, a second survey comprising a second plurality of questions;

receiving, by said computing system, second data from said first management party in response to said second survey, said second data comprising first management supplied information associated with said first resource, said first management party, and said first group of projects;

first analyzing, by said computing system, said first data with respect to said second data;

generating based on said first analyzing, by said computing system, a first resource specification report associated with said first resource;

generating based on said first analyzing, by said computing system, a first project model comprising first projected requirements for each project of said first group of projects; and

generating based on said first analyzing and said first project model, by said computing system, a first project specification report comprising first actual requirements for said first group of projects with respect to said first projected requirements for said first group of projects.

The present invention provides a process for supporting computer infrastructure, said process comprising providing at least one support service for at least one of creating, integrating, hosting, maintaining, and deploying computer-readable code in a computing system, wherein the code in combination with the computing system is capable of performing a personnel management method, said method comprising:

presenting to a first resource, by said computing system, a first survey comprising a first plurality of questions;

receiving, by said computing system, first data from said first resource in response to said first survey, said first data comprising first resource supplied information associated with: said first resource, a first management party associated with said first resource, and a first group of projects associated with said first resource;

presenting to said first management party, by said computing system, a second survey comprising a second plurality of questions;

receiving, by said computing system, second data from said first management party in response to said second survey, said second data comprising first management supplied information associated with said first resource, said first management party, and said first group of projects;

first analyzing, by said computing system, said first data with respect to said second data;

generating based on said first analyzing, by said computing system, a first resource specification report associated with said first resource;

generating based on said first analyzing, by said computing system, a first project model comprising first projected requirements for each project of said first group of projects; and

generating based on said first analyzing and said first project model, by said computing system, a first project specification report comprising first actual requirements for said first group of projects with respect to said first projected requirements for said first group of projects.

The present invention provides a computer program product, comprising a computer usable medium comprising a computer readable program code embodied therein, said computer readable program code adapted to implement a personnel management method within a computing system, said method comprising:

presenting to a first resource, by said computing system, a first survey comprising a first plurality of questions;

receiving, by said computing system, first data from said first resource in response to said first survey, said first data comprising first resource supplied information associated with: said first resource, a first management party associated with said first resource, and a first group of projects associated with said first resource;

presenting to said first management party, by said computing system, a second survey comprising a second plurality of questions;

receiving, by said computing system, second data from said first management party in response to said second survey, said second data comprising first management supplied information associated with said first resource, said first management party, and said first group of projects;

first analyzing, by said computing system, said first data with respect to said second data;

generating based on said first analyzing, by said computing system, a first resource specification report associated with said first resource;

generating based on said first analyzing, by said computing system, a first project model comprising first projected requirements for each project of said first group of projects; and

generating based on said first analyzing and said first project model, by said computing system, a first project specification report comprising first actual requirements for said first group of projects with respect to said first projected requirements for said first group of projects.

The present invention advantageously provides a method and associated system capable of selecting individuals to perform specified functions.

### BRIEF DESCRIPTION OF THE DRAWINGS

FIG. 1 illustrates a block diagram of a personnel management system, in accordance with embodiments of the present invention.

FIG. 2 illustrates a flowchart describing an algorithm for generating a survey within the personnel management system of FIG. 1, in accordance with embodiments of the present invention.

FIG. 3 illustrates a flowchart describing an algorithm for collecting resource data within the personnel management system of FIG. 1, in accordance with embodiments of the present invention.

FIG. 4 illustrates a flowchart describing an algorithm for resource requirement mapping within the personnel management system of FIG. 1, in accordance with embodiments of the present invention.

FIG. 5 illustrates a flowchart describing an algorithm for an ad hoc correlation of data process performed within the personnel management system of FIG. 1, in accordance with embodiments of the present invention.

FIG.6 illustrates a computer apparatus used for generating reports and resource/project associations within the personnel management system of FIG. 1, in accordance with embodiments of the present invention.

### DETAILED DESCRIPTION OF THE INVENTION

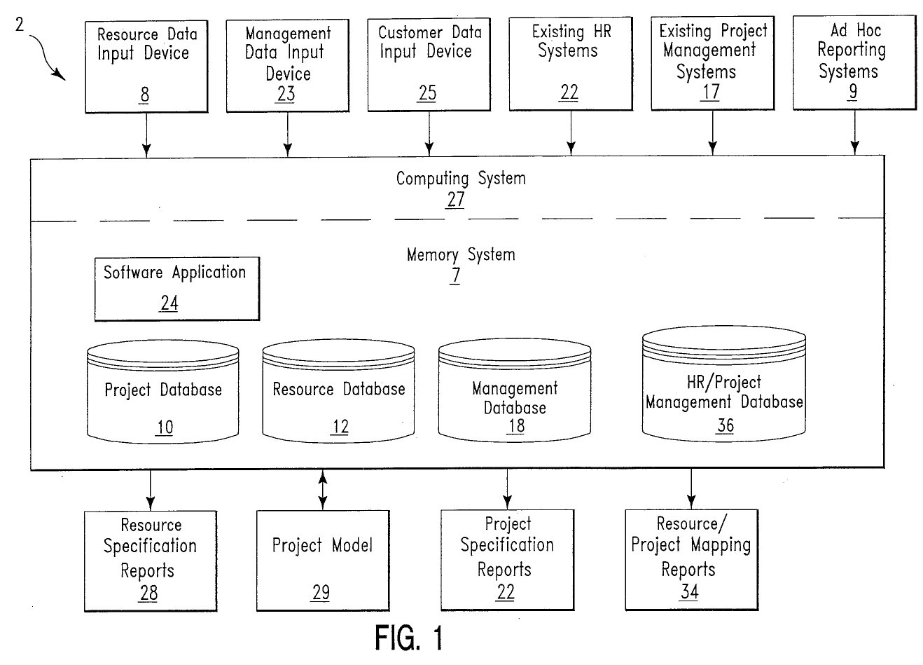

FIG. 1 illustrates a block diagram of a personnel management system 2, in accordance with embodiments of the present invention. Personnel management system 2 comprises a computing system 7, a resource data input device 8, a management data input device 23, a customer data input device 25, existing human resource (HR) systems 22, ad hoc reporting systems 9, and existing project management systems 17. Computing system 27 comprises a memory system 7. Memory system 7 comprises a software application 24, a project database 10, a resource database, 12, a management database 18, and an HR/Project management database 36, Computing system 27 may comprise a single computing apparatus (e.g., a server) or a plurality of networked computing apparatuses. Each of project database 10, resource database, 12, management database 18, and HR/Project management database 36 may be located internal to computing system 27 (i.e., as illustrated in FIG. 1) or external to computing system 27. Software application 24 uses data retrieved from resource data input device 8, management data input device 23, customer data input device 25, existing human resource (HR) systems 22, ad hoc reporting systems 9, and existing project management systems 17 to generate as an output: resource specification reports 28, project models 29, project specification reports, and resource/project mapping reports 34. Resource specification reports 28, project models 29, project specification reports, and resource/project mapping reports 34 may be retrieved and viewed via any type of input/output device including, inter alia, a computer monitor, a printer, etc. Resource data input device 8 is used by a resource (i.e., an employee or sub-contractor who will be performing work on a project for a company on behalf of a staffing company) to input self provided resource data, management data, and project data into computing system 27 for storage in resource database 10 (i.e., for resource data), project database 12 (i.e., for project data), management database 18 (i.e., for management data), and processing by software application 24. The resource data (i.e., provided by the resource) may comprise resource related data associated with standard skills and experience aptitude test results, non-confidential periodic survey results, hours worked, project evaluations, etc. The project data (i.e., provided by the resource) may comprise responses from periodic surveys rating a project on several characteristics including: clarity of purpose, degree of skill required, stressfulness, non-controllable factors, difficulty of customer availability of tools/resources necessary to perform, etc. Management data input device 23 is used by a manager(s) associated with a project(s) and/or the resource to input management provided resource data, management data, and project data into computing system 27 for storage in resource database 10 (i.e., for resource data), management database 18 (i.e., for management data), project database 12 (i.e., for project data) and processing by software application 24. The resource data (i.e., provided by the manager(s)) may comprise appraisals, detailed project feedback, etc. The detailed project feedback may comprise assessments versus individual role requirements and peer-based, (e.g., degree of leadership exhibited/leadership required, breakthrough thinking displayed, an amount of direction required, quality of sub-deliverables, etc). The project data (i.e., provided by the manager(s)) may comprise periodic surveys rating the project on several characteristics including degree of skill required versus anticipated, quality of deliverables, customer relationship, non-controllable factors, appropriateness of resources for the required tasks, customer apparent satisfaction, etc. Customer data input device 25 is used by a customer (e.g., associated with a project or the resource) to input resource data, management data, and project data into computing system 27 for storage in resource database 10 (i.e., for resource data), management database 18 (i.e., for management data), project database 12 (i.e., for project data) and processing by software application 24. Existing HR systems 22 and existing project management systems 17 input existing resource and/or project related data into computing system 27. Computing system 27 in combination with software application 24 uses the aforementioned data retrieved from resource data input device 8, management data input device 23, customer data input device 25, existing human resource (HR) systems 22, ad hoc reporting systems 9, and existing project management systems 17 to generate as an output: resource specification reports 28, project models 29, project specification reports 32, and resource/project mapping reports 34 in order to associate a specific resource(s) with a specific project (i.e., for performing job related functions associated with the project). Computing system 27 in combination with software application 24 allows for the following functionality:
1. Collection and consolidation of detailed project, personnel, and management survey feedback during multiple phases of a project lifecycle.
2. Dynamic generation of project surveys based upon a customized project model and resource and management characteristics and preferences.
3. Translation of a project pre-assessment (i.e., a questionnaire driven customization of an existing project model) into a working project model comprising inherited and calculated statistics for the purpose of enabling a personnel management system.
4. Collation of data from disparate sources (e.g., resources, management, customers, existing human resource (HR) systems, ad hoc reporting systems, and existing project management systems) for storage within a repository (e.g., project database 10, resource database, 12, management database 18, HR/Project management database 36, etc). The data is used to create statistical profiles and performance correlations (e.g., resource specification reports 28, project models 29, project specification reports 32, and resource/project mapping reports 34). The data is retrieved:
   A. At a resource level (i.e., retrieving statistics particular to one employee throughout an employment history which may be viewed for all projects, for a specific project, or for customized aggregates of projects).
   B. At a project level where data may be grouped in several ways including, by types of projects, by specific project characteristics, by customer, etc.
   C. At a project management level where data may be grouped in several ways including, performance and operational characteristics of individual project managers, at larger project levels, team, department and several hierarchical levels as far up as an enterprise, etc.
5. Correlation of statistics (e.g., one to another, one to many, many to many, etc) in order to determine relationships between data collected from resources, management, and customers (i.e., internal data) and external data collected from external systems (e.g., HR systems 22 and/or project management systems 17), such that:
   A. Self-reported resource performance, characteristic and preference data may be compared with peer or management-reported data.
      A1. Providing a measure of correspondence between self-assessed, peer-assessed, and management assessed data to be used in assigning a weight to data sources.
      A2. Normalizing subjective data inputs.
      A3. Identifying abnormalities and determining outcomes in instances where resource, management, and customer perceptions vary.
   B. Resource data (e.g., from resource data input device 8, management data input device 23, customer data input device 25, existing human resource (HR) systems 22, ad hoc reporting systems 9, existing project management systems 17, etc) may be correlated for an individual versus a variety of project characteristics.
      B 1. Determining operating characteristics of a resource as a function of the types of projects undertaken and across variations in a working environment.
      B2. Determining fluctuations over time, multiple resources, and projects. The fluctuations illustrate a degree in which measures of performance and quality fluctuate for an individual or team on a project in relation to how closely the project's characteristics map to the resources self-identified preferences.
   C. Inputted data may be correlated for a team or project manager versus varying project conditions, thereby demonstrating a way in which team performance maps to self-assessed preference, historical performance, and varying project conditions.
      C1. The inputted data will allow improvement of project delivery and personnel management by clarifying the data relationships.
      C2. The inputted data will allow companies to identify situations and conditions which adversely correlate to performance, customer satisfaction, solution quality, and profitability, and actively mitigate them on future engagements.
   D. Computing system 27 will generate: comprehensive surveys and imported objective project and performance measurements including, inter alia:
      D1. A number of defects,
      D2. An overall project success or failure.
      D3. Customer satisfaction data (broken out by overall project, phases, sub-deliverables, etc).
      D4. Percent attainment of statistical objectives including, SLAs (service level agreements).
      D5. Financial measurements including cost, expense, and profit.
      D6. Scheduling information including percent of deadlines met.
   E. Computing system 27 will provide several types of documents as standard outputs including:
      E1. Resource specification reports which group both internal data (e.g., resource data) and external data (e.g., HR data) for a particular employee into a profile that may be used by a staffing manager looking to fill particular positions. Standard correlations of preferences and characteristics to performance will be included in order to provide a statistical projection of resource projection versus a given project model,
      E2. Project models that are customized to represent a particular project and inherit statistical information from computing system 27 based upon their pre-assessed characteristics to serve as a basis for running resource mappings against them.
      E3. Project specification reports which are an actualized project model comprising data collected during and after a project has completed.
      E4. Employee project mapping reports in which an employee (i.e., resource) is mapped against a potential project such that that employee's preferences and past performance are correlated with the anticipated (via the pre-assessment and customization of the project model) project characteristics in order to determine optimal matching of resource to requirement. Employee/project mapping reports allow staffing managers to ‘tie break’ between similarly skilled employees which meet the experience criteria for an engagement and enable them select the resource, based upon their data history, with a better statistical chance of succeeding. Employee/project mapping may also be used internally by mapping candidate scorings on surveys with internal positions open and needing to be filled in order to maximize the value for the employer and maximize opportunities for success of the employee.

The following description describes architecture and interfaces for computing system 27. In FIG. 1, data is retrieved by computing system 27 from various sources including, resources, management parties, customers, HR systems, and external management systems.

### Resource Data Collection

Resource data collected from a resource may comprise time sheet information and responses to project surveys. Resource data collected from a manager with respect to the resource may comprise information related to a degree of leadership exhibited, breakthrough thinking displayed, an amount of direction required, a quality of sub-deliverables, assessments versus individual role, and peer-based assessments.

### Management Data Collection

Management data collected from a resource may comprise non-confidential periodic resource survey results, resource self-provided data allocated to a project manager. Management data collected from a customer may comprise customer project survey data, project leadership assessments (e.g., feedback on attributes specific to that project manager's performance including, leadership displayed, quality of project management, effective resolution of problems, etc). Management data collected from management (i.e., self provided) may comprise project leadership self-assessments (e.g., leadership displayed, quality of project management, effective resolution of problems, etc), service level agreement data, etc.

### Project Data Collection

Project data collected from a resource may be retrieved via periodic surveys given to the resource. The periodic surveys are used to rate projects for several characteristics including:
1. Clarity of objectives.
2. Degree of skills required.
3. Stressfulness.
4. Non-controllable factors.
5. ‘Difficulty’ of customer
6. Availability of tools/resources necessary to perform:
   A. Availability of (non-personnel) resources to perform work.
   B. Efficiency of processes employed on project
   C. Overall quality of project.
   D. Overall quality of project management.

Project data collected from management (i.e., via periodic surveys) may comprise information rating a project on:
1. A degree of skill required versus anticipated/estimated.
2. A quality of deliverables.
3. A customer relationship.
4. Customer satisfaction.
5. Non-controllable factors.
6. Suitability of (personnel) resources for the required tasks.
7. Availability of (non-personnel) resources to perform work.

Project data collected from a customer may comprise information related to an ease of doing business, a quality of deliverables, an overall project quality, an adherence to controls, an adherence to terms of a contract (e.g., scope, schedule, budget, service level agreement attainment, etc), etc.

Project data collected for a new project pre-assessment is obtained via customization of project models 29 and the use of customer questionnaire data. The customer questionnaire data may comprise:
1. A stringency and formality of project processes.
2. Degree of autonomy afforded resources.
3. Adherence to industry standards or best practices (controls).
4. A similarity to previous work (i.e., percent ‘new’ versus ‘reused’ methodologies and work products).
5. Anticipated stressfulness.
6. Criticality of project.
7. Presence of clear success/failure criteria.

All data collected from resources, management parties, and customers is assigned IDs. For example, data is associated to project identifier (i.e., project ID) which decomposes to a project phase ID and a project task ID. Unique IDs are generated for resources on project, project managers, and customers.

All data collected from resources, management parties, and customers is stored in resource database, 12, management database 18, and project database 10 respectively. Each of the aforementioned databases maintain object relationships between the aforementioned IDs. All resource data will be allocated to the resource ID(s) of the personnel for the given task ID, their assigned project manager, project phase, project, and customer. Therefore aggregated data may be viewed at a resource (individual or team) level, project phase level, project manager level, etc.

Existing HR systems 22 transmit existing HR personnel information (data) associated with a resource. The personnel information may include appraisal ratings, appraisal for previous assignments, skills levels, educational level, experience data, training received, utilization history, aptitude/personality survey data, incidences of health problems, incidences of disciplinary actions, number of transfers out of departments, number of resources leaving company, resource satisfaction info, resource reported work preference data, resource self-assessment data, management & peer assessment data, correlated performance data (i.e., vs. assignment/job role, vs. project attribute data), etc.

Existing project management systems 17 transmit existing project management information (data) associated with a project. The project management information may include:
1. Project management system data at a project level including:
   A. Base project information.
   B. Project phases, milestones, tasks.
   C. Project deliverables.
   D. Staffing data.
   E. Scheduling data.
   F. Project results data.
2. Project management system data at an aggregated project level which is the same as for individual projects but allows analysis of project data at higher level (i.e., across larger organization, or multiple projects over time).
3. Specific project assessment data including:
   A. Resource reported project data.
   B. Customer reported project data.
   C. Project manager project assessment data.

Ad hoc reporting systems 9 comprises a facility for allowing users of computing system 27 to run queries versus databases 28, 29, 32, and 34. Analysts may use computing system 27 to view data as it exists within the databases 28, 29, 32, and 34 or run correlations of data to uncover relationships.

Software application 24 calculates correlations between data retrieved from resource data input device 8, management data input device 23, customer data input device 25, existing human resource (HR) systems 22, ad hoc reporting systems 9, and existing project management systems 17 to generate as an output: resource specification reports 28, project models 29, project specification reports, and resource/project mapping reports 34. The correlations calculated may include:
1. Self-reported resource work preferences vs. project attributes and assessed quality measurements such as:
   A. Project with rigid processes and controls.
   B. Project with assessed weak leadership.
   C. Project with tight budgetary constraints.
   D. Project with management reported resource constraints.
2. Project management self-assessments vs. customer satisfaction results.
3. Project attributes vs. resource-ratings of project managers.
4. Project results vs. % utilization (i.e., overtime worked) of resources.
5. Project results vs. project management customer assessments vs. project attributes.

Software application 24 generates resource specification reports 28, project models 29, project specification reports, and resource/project mapping reports 34 using the aforementioned data.

### Resource Specification Reports

Resource specifications reports comprise:
1. A statistical profile of resource work preferences.
2. A listing of resource skills, experience and ranking data.
3. Peer-adjusted resource performance statistics.
4. A statistical comparison of resource performance as function of types of assignments.

### Project Models

Project models comprise:
1. Technical descriptions of engagements used to determine likely project attributes and specifications.
2. A listing of required skills.
3. Optimal resource profiles for staffing, based upon characteristics and specifications.
4. Predictive information, including proactive risk identification and proposed (staffing) mitigations.

### Project Specification Reports

Project specification reports comprise:
1. Output for specific projects.
2. A statistical profile of project characteristics.
3. A statistical (‘as-staffed’) record of actual staffing vs. modeled requirements including:
   A. Identification of major gaps in skills.
   B. Identification of major gaps in preference or aptitude.
   C. Identification of gaps in predicted vs. actual characteristics,
4. A statistical comparison between resource and immediate peers' performance.
5. A record of project success/failure, as well as quantitative measures.
6. Project metrics including:
   A. Customer satisfaction.
   B. Costs.
   C. Service level agreements and/or milestone objectives reached.
   D. Profitability.
   E. Resource utilizations.
7. A statistical comparison of project to overall project portfolio, across all tracked characteristics and metrics.

### Resource/Project Mapping Reports

Resource/Project mapping reports identify a ‘best-fit’ (along several axes) between available resources and potential projects based on:
1. Resource preference.
2. Matching of project requirements to resource characteristics.
3. Best-fit of overall available resources and projects requiring staffing and may be modeled to maximize various outcomes, including customer satisfaction, profitability, resource satisfaction, reduction of expense, etc.

The following description illustrates threes examples of implementing personnel management system 2 of FIG. 1 to retrieve data generate resource specification reports 28, project models 29, project specification reports, and resource/project mapping reports 34.

### EXAMPLE 1

Example 1 illustrates a scenario where a project executive must staff a Sr. developer on an existing account. In this scenario, an applications services provider must fill a senior developer position on an existing project from its resource pool. The hiring manager pulls a project specification report for the project in order to review the characteristics of the engagement. The project is rated as 2.1 out of 5 for structured processes thereby putting it closer to an unstructured end of the spectrum with respect to the degree of process formalization and adherence to industry development and management methodologies and best practices. Additionally, this particular project is rated 4.6 (out of 5) for complexity, and scheduling issues. Staffing constraints have the project running at an average of 115% resource (employee) utilization in billable hours. The team already working on the project, through 30% completion, have rated the project thus far as having less than adequate (2.3 out of 5) resources for the job, and have assigned an assessment of ‘adequate’ to their lead Project Manager. According to a formula that looks at how many key project metrics are above or below certain thresholds, as well as the scope of the work which will be done by the person hired, this staffing decision is flagged as ‘Critical’ by computing system 27. A skills search is executed by a project executive. Computing system 27 queries the company's human resources system's skills database (e.g., database 36), and retrieves a number of candidates with the required technical and leadership expertise while factoring out those who are unavailable due to deployment on other projects. Two resource (resource A and resource B) resumes are returned by the HR system (e.g., existing HR systems 22) to computing system 22, where their respective specification reports are automatically pulled and cross-referenced with the staffing requirements. According to their resource specification reports, collections of statistics characteristics and preferences, and a listing of skills and experience, resource A and resource B both exceed the required knowledge in the customer's application area, as well as leadership experience. According to the resource/project mapping function in software application 24, the following resource specification data is taken into consideration:
Morale vs. Technical Leadership Correlation: Resource A's satisfaction dips by 30% on projects without clear technical leadership. Resource B's morale falls by 12% under the same circumstance.
Performance Rating vs. Stress: Both resources exhibit general performance ratings which are in the 90^{th} percentile for the company. Resource B's general performance rating is 0.7% less than resource A's, but under high stress conditions, resource B's peer-adjusted performance rating (his rating as compared with similarly skilled resources under the same conditions) increases by 16%, whereas resource A's is only +1%.
Performance, Morale vs. Utilization: Resource A's performance and satisfaction remain level while working from 20-25% overtime (120-125% utilization), resource B's drops by 3%.
Performance vs. Job Role Definition: Resource A's performance declines by 8% when he perceives that he is asked to do work outside of the primary job description. Resource B's performance actually improves (+11%) in less rigid environments, where responsibilities are dynamic.

Therefore, the data above illustrates that resource B is a better candidate for the open position, given that the project is high stress and loosely managed, will likely require high amounts of overtime, and that this particular position is considered very critical to the overall project's success. Resource B may not only have an excellent chance of success, but may so impress the customer that the staffing company may win additional work. Resource A may very well fulfill the base terms of the contract but given the profile presented, will not maximize customer satisfaction and create the opportunity for additional business.

### EXAMPLE 2

Example 2 illustrates a scenario where personnel management system 2 researches statistical differences between most and least profitable projects. In this scenario, a consulting firm has deployed personnel management system 2 in order to gather data and assist in staffing critical resources. The company now wishes to use computing system 27 within personnel management system 2 for business intelligence in order to conduct an analysis of the correlation of various factors on project profitability. Initially, they decide that they will analyze their top 10% and bottom 10% profitable contracts over a given time period. They discard those which had major factors, positive or negative, which were unlikely to apply to the rest of their business (for example, one client was bought out by a competitor, and therefore began aggressively looking for a way to terminate the contract). Using computing system 27, an analyst aggregates the project specification reports (themselves representations of data gathered from the project resources, managers, customers, as well as information gleaned from the new project pre-assessments and customer profiles) for the top and bottom ten percent profitable projects. The analyst enters ‘profitability’ into his ad-hoc correlation report, at the ‘project’ level, as his primary criterion, and then executes the analysis. Computing system 27 returns the project characteristics which best correlate to profitability as given by the order of the most profitable projects. Of these, in this example, customer satisfaction and clarity of objectives are the two project characteristics which best correlate with profitability. Computing system 27 then attempts a raw correlation between resource characteristics and project profitability and returns employee morale as a slight correlation. The analyst then refines the correlation criteria and searches instead for the resource characteristics that correlate to the customer Satisfaction and clarity of objectives characteristics of projects, which returns employee morale, utilization, and technical leadership of project manager as significantly correlated factors. After finding these correlations for the most (and least) profitable projects, the analyst will then run a correlation for all projects between those resource characteristics (i.e., morale, utilization, and technical leadership of project manager) and those project characteristics (customer satisfaction and clarity of objectives), to determine whether the correlations hold up across all projects. Per the data considered, it is determined that the correlations do hold up across the entire set of projects, Satisfied with the correlations, the analyst then isolates the resource characteristics individually and in a three-way aggregate and then runs correlations for these factors versus the rest of the databases (database 10, 12, 18, and 36). Finally, this analysis yields a strong correlation between project manager experience and technical ability and on the project side, completeness of requirements gathering. The analyst then reports these findings to the executive management team of the consulting company who in response, implement two new policies to improve project profitability. The company uses the data that it has gathered via computing system 27 to determine that in situations where the project requirements are acknowledged upfront as being less than clear, it is absolutely critical to ensure that the project is led by their most senior and technical project managers in order to ensure profitability. While improvements to the requirements gathering process on projects is a long term objective, the project manager staffing boils down to a relative few key personnel decisions. A management decision is reached, determining that, for the good of the company, if a ‘profitability risk’ project must be staffed, the company's new executive-backed policy will be to roll off a senior project manager with the requisite skills from another, lower risk project, rather than staff it with the ‘best available’ project manager, as this practice is statistically the best and easiest course of action to mitigate the project profitability risk. The impacts of these changes may then be measured by the data from future projects.

### EXAMPLE 3

Example 3 illustrates a scenario where computing system 27 selects the appropriate internal development team to support a new project. In this scenario, a company has a new initiative which will result in an internal technical project. They have a number of different teams internally to which the work can be assigned. The staffing manager selects a project model from computing system 27 and uses it as a base from which to fill out a new project pre-assessment for the work. Once this pre-assessment is completed, she reviews the resulting project specification report to determine the projects characteristics. Based upon these characteristics, she performs a search of available teams with the requisite skills and capacity to perform the work (computing system 27 rolls tip the characteristics of individual resources to the team and department levels, for as many hierarchies are defined within the company). This essentially becomes an employee/project mapping exercise performed at a team level (i.e., an aggregation of resources). Three departments within the company have expressed interest in performing the work, responded to the project requisition, and have the required skills and experience to perform the work. The project is rated as a static engagement with well-defined objectives, mature delivery processes, and relatively low-stress. One of the teams is ruled out because they are essentially over-qualified, having the ability to perform on high stress, ill-defined projects. An indicator in the computing system 27 illustrates that such teams are in high demand for external engagements. Therefore this particular project would not maximize their benefit to the company. Simply stated, if Team A can do the work that Team B or Team C can do, but neither Team B nor Team C can perform the work of Team A, it is better to reserve Team A for that more difficult and more critical work. Team B and C both match up well with the requirements, from a skills and experience perspective, as well as when considering preferences and work styles as obtained from aggregation of their respective resource characteristics. Given that information, the project is awarded to Team C which has a lower cost basis and will allow the work to be done at a greater profit.

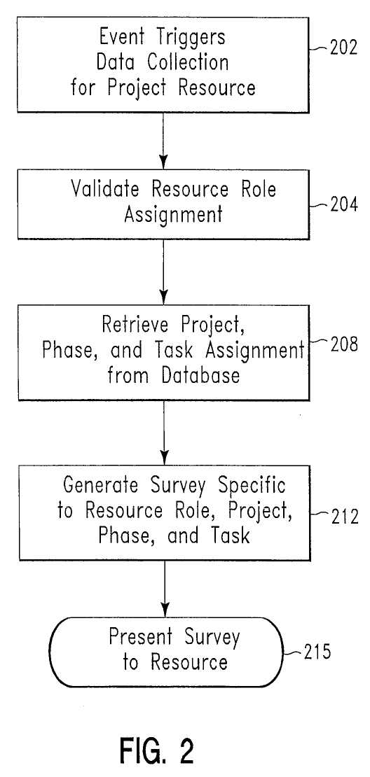

FIG. 2 illustrates a flowchart describing an algorithm for generating a survey within personnel management system 2 of FIG. 1, in accordance with embodiments of the present invention. In step 202, an event triggers a data collection process for project resource (i.e., within computing system 27). The event may comprise be triggered by:
1. User initiation.
2. At a start of a project.
3. Upon task completion.
4. At a phase exit.
5. Upon a project completion.

In step 204, a resource role assignment is validated in order to ensure no changes to the assignment so that data is allocated to correct IDs. In step 208, project, phase, and task assignment data is retrieved from the databases (e.g., databases 10, 12, 18, and 36 of FIG. 1). In step 212, a survey is generated for collecting data used for measurement points specific to a task/phase/project. In step 215, the survey from step 212 is presented to the resource for completion. Computing system 27 may allow for a web-enabled completion of survey (e.g., synchronous or non-synchronous). The survey may comprise indicators for a self-reporting of labor claiming/project hour tracking. The survey may be given periodically thereby generating micro-measurements. For example, the survey may comprise 5 minute electronic, web-based surveys on task completion such as:
1. 5 minute per measurements (survey) at lowest level of granularity (task completion).
2. Point and click data entry for pre-populated choices to minimize effort required.
3. Geared to assessment of resources, project management and project.

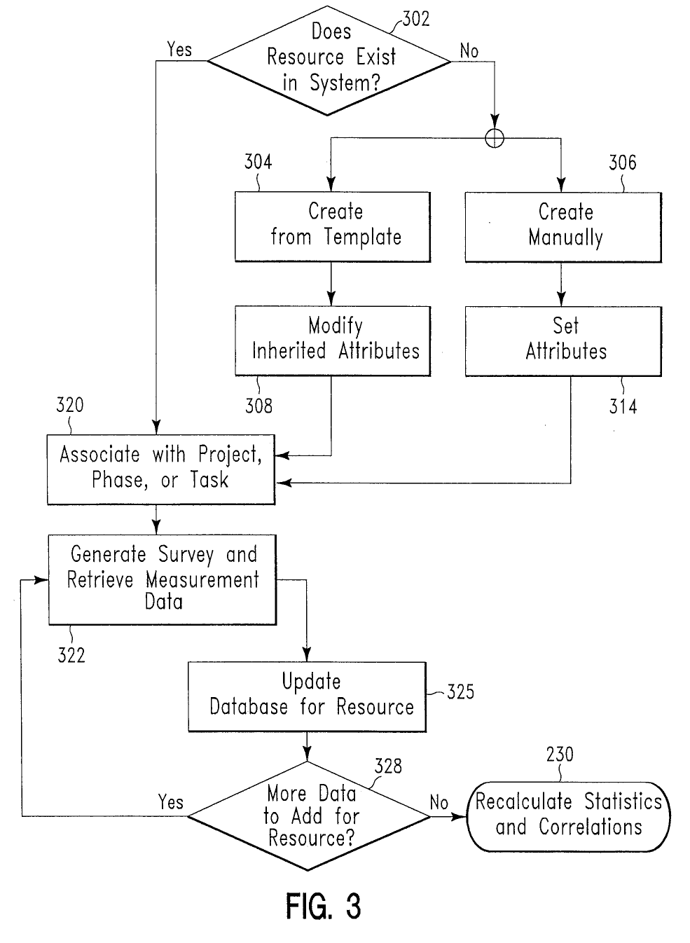

FIG. 3 illustrates a flowchart describing an algorithm for collecting resource data within personnel management system 2 of FIG. 1, in accordance with embodiments of the present invention. The algorithm described in FIG. 3 may also apply to the collection of management data and project data. In step 302, it is determined if the resource exists within personnel management system 2.

If in step 302, it is determined that the resource does not exist within personnel management system 2 then in step 306, a profile for the resource is created manually and attributes are set in step 314 and step 320 is executed as described, infro. Alternatively, in step 304, a profile the resource may be created from a template and instep 308, inherited attributes are modified and step 320 is executed as described, infra.

If in step 302, it is determined that the resource does exist within personnel management system 2 then the process directly executes step 320. In step 320, the resource is associated with a project, phase or task. An association with a task associates the resource with objects further up the hierarchy (e.g., phase, project). In step 322, appropriate surveys are generated and resource data is retrieved. In step 325, the databases are updated for the resource. In step 328, it is determined if more data is required. If in step 328, it is determined that more data is required then step 322 is repeated. If in step 328, it is determined that more data is not required then in step 330, aggregated statistics and stored correlations are recalculated,

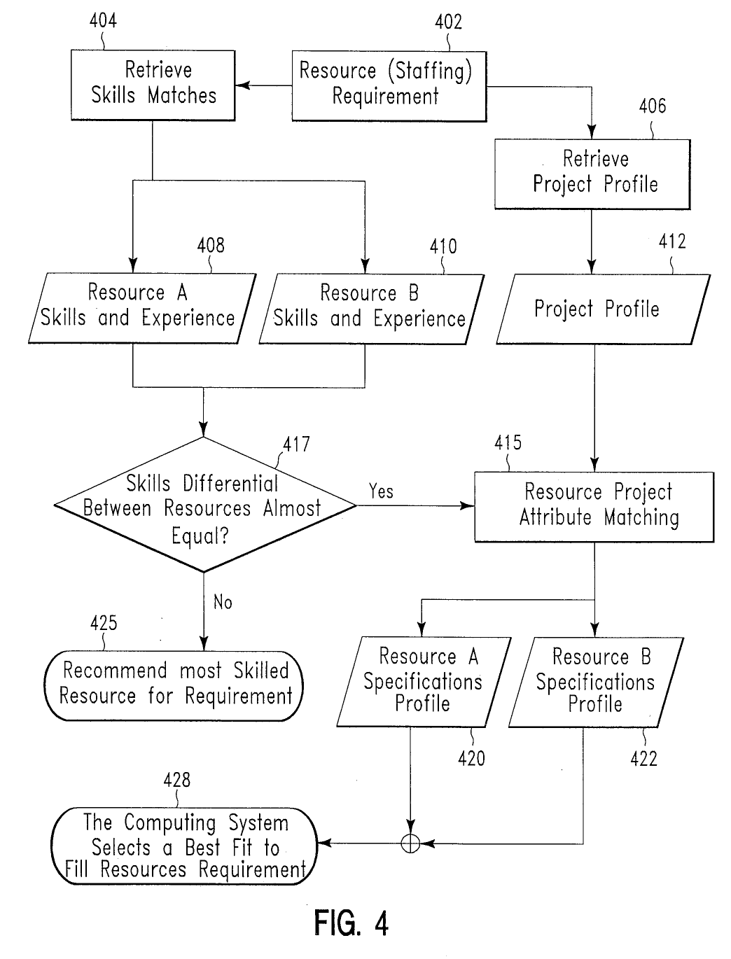

FIG. 4 illustrates a flowchart describing an algorithm for resource requirement mapping within personnel management system 2 of FIG. 1, in accordance with embodiments of the present invention. In step 402, resource requirements are entered into computing system 27. The resource requirements may comprise:
1. Skills requirement(s) for position to be staffed.
2. Experience requirement(s) for position to be staffed.
3. Weights that may be assigned to desired qualifications.

In step 408, skills matches are retrieved from data in databases 10, 12, 18, and 36. The skills data may be loaded into databases 10, 12, 18, or 36 or alternatively may be retrieved via an interface to an external human resources database (e.g., existing HR systems 9). In response, computing system 27 returns a designated number of resources who fulfill the skills and experience requirements. In step 406, project profile for position to be staffed is retrieved. Queries are sent to computing system 27 to retrieve characteristic data of project being staffed. Initial project profile characteristics data is generated from a new project pre-assessment. Additional data is captured on an ongoing basis for projects in process. Project characteristics information is maintained for a comparison of resource characteristic data, if necessary. In step 412, a project profile is presented. The project profile may comprise indications that a project is:
1. Behind schedule.
2. Comprises immature governance processes.
3. High pressure.
4. Below a target customer satisfaction.
5. Comprises high utilization requirements.
   A requester (staffing manager) may add weighting to various project characteristics to facilitate mapping.

In step 408, a skills profile presented for a potential candidate A. In step 410, a skills profile is presented for a potential candidate B. Each skills profile from step 408 and 410 may comprise a resume of skills information including, inter alia, a history, a skills list, experience, etc. The skills profiles provide a ranking similar to search engine relevance in order to indicate how closely each resource meets the skills and experience criteria for the position. In step 417, it is determined if skills differences between resources (e.g., resource A and resource B) are almost equal by comparing proposed resources with requirements. Step 417 is used to
1. Determine whether there is a clear ‘best-fit’ candidate based upon the skills and experience criteria.
2. If multiple candidates satisfy the minimum range of skills and requirements for the position and their variance is within a defined range. Computing system data is used as a tie breaker.

If in step 417, it is determined that skills differences between resources (e.g., resource A and resource B) are almost equal then in step 415, computing system 27 performs a resource project attribute matching process. The project attribute matching process comprises:
1. Retrieving resource specifications profiles for subset of candidates who meet the skills and experience criteria.
2. Comparing employee characteristic data (self, peer and management assessed) with the project specifications.
3. Applying weightings by the staffing manager in order to indicate which characteristics are most critical or desirable.

In step 420, specification data is returned for resource A. In step 422, specification data is returned for resource B. The specification data for candidate A and B may comprise:
1. Resource characteristics as correlated with weighted factors in the project attributes.
2. The resources ranked based upon projected performance on the project based upon correlation of their historical performance with those factors.
3. A determination whether there is a clear ‘best-fit’ candidate based upon resource project characteristics mapping.

In step 428, computing system 27 recommends a ‘best fit’ resource (i.e., resource A or resource B) for requirement.

If in step 417, it is determined that skills differences between resources (e.g., resource A and resource B) are not almost equal then in step 425, computing system 27 recommends a most skilled resource for requirement.

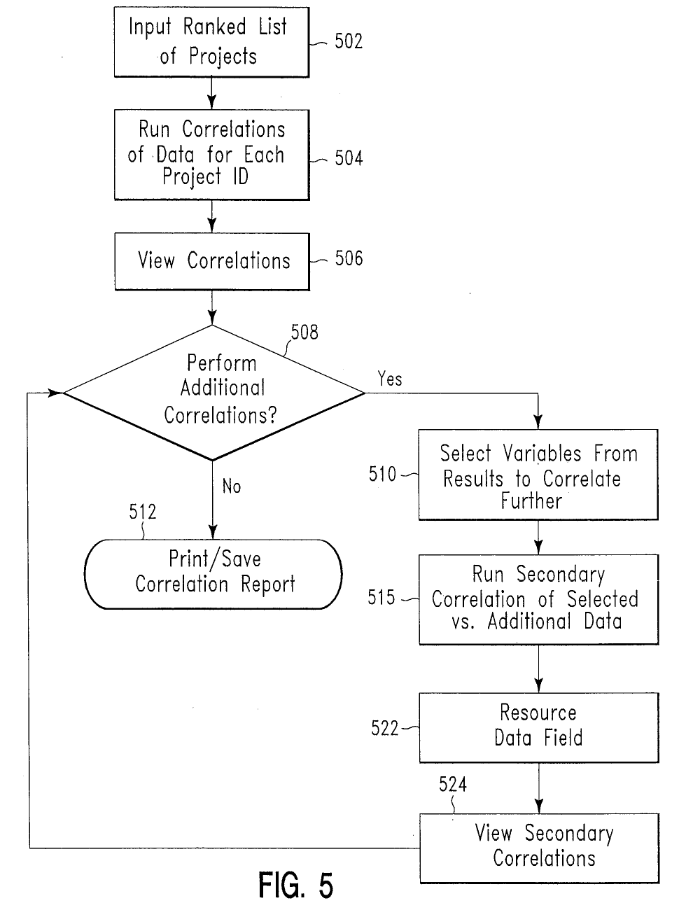

FIG. 5 illustrates a flowchart describing an algorithm for an ad hoc correlation of data process performed within personnel management system 2 of FIG. 1, in accordance with embodiments of the present invention. In step 502, a ranked list of projects is imputed into computing system 27. A report may be run within computing system 27 or alternatively information may be gathered externally. For example, the top or bottom 10% in project profitability as a percentage of revenue may be entered into computing system 27 via ad hoc reporting systems 9. All project specification data for those projects will be retrieved and listed. This data will be standardized to allow comparison with data with different magnitudes or different units. In step 504, correlations of data are run for each project ID. All of the project specification data is tested for correlation with the ranking data. In step 506, correlation data is presented to the analyst. Any columns containing correlations greater than a default or user-specified magnitude are presented in ranked order. For example:
1. Condition A—45% correlation.
2. Condition B—42% correlation.
3. Condition C—26% correlation.

The analyst may also choose a data view, illustrating either the standardized or raw values for the given project, the ranked data, and the columns which meet the correlation criteria. For example:
1. ProjectID|Top10% Prof|Condition A|Condition B| . . .

In step 508, it is determined if additional correlations of data should be run for each project ID. Step 508 allows the analyst an opportunity to accept first tier correlation (of data that exists within the project specification sheet) or perform further correlations.

If In step 508, it is determined that additional correlations of data should not be run for each project ID then in step 512, a correlation report is printed and/or saved within computing system 27.

If In step 508, it is determined that additional correlations of data should be run for each project ID then in step 510, variables are selected from the results in order to perform additional correlations. This allows the analyst an opportunity to select variables from the first correlation in order to correlate further. The analyst may select highlighted variables (as contained in the columns returned as having greater than default/designated correlation with the provided ranked criteria) or other variables which were not highlighted. In step 515, a secondary correlation of selected variables versus additional computing system 27 data is run. This allows the analyst an opportunity to select variables from the first correlation to correlate further. The analyst is presented with a high-level view of other data that may be selected. The data has an object relationship to project data via the ProjectID (unique identifier for all projects, such that computing system 27 databases may be searched for all resources, all customers, etc., belonging to a particular project ID. Any data which is not stored directly with project specification data, if selected here, will be queried from its location and summed in temporary storage used by the correlation function. A magnitude of correlation may be specified again at this step to override the default value. In step data is retrieved for a secondary correlation run. For example:
1. Data corresponding to the selected variables is retrieved from its location and summed, as necessary.
2. Data for the variables in the secondary correlation is standardized and placed in temporary storage.
3. Correlations are performed between all of the columns in the secondary correlation run and the data from step 510.

In step 524, secondary correlations are viewed. Any data corresponding to the selected variables is retrieved from their locations within computing system 27 databases and summed, as necessary. For a one to many correlation (as in step 506), the resulting presentation and options are the same. Any columns containing correlations greater than a default or user-specified magnitude are presented in ranked order. For example:
1. Condition A—45% correlation
2. Condition B—42% correlation
3. Condition C—26% correlation

The analyst may also choose a data view, illustrating either the standardized or raw values for the given project, the ranked data, and the columns which meet the correlation criteria:

### 1. ProjectID|Top 10% Prof|Condition A|Condition B| . . .

For a many-to-many correlation, the analyst may use an isolated or aggregated correlation among the variables. For an isolated correlation, each variable selected in step 510 is correlated versus the additionally selected computing system 27 data fields. For an aggregated correlation, the standardized values of the selected variables are averaged and then treated as a single variable in the correlation with the additional data fields. Alternatively, an aggregated correlation may be determined for the additional data by calculating an additional column composed of the average of the standardized data, which will then be correlated with the values selected in step 510.

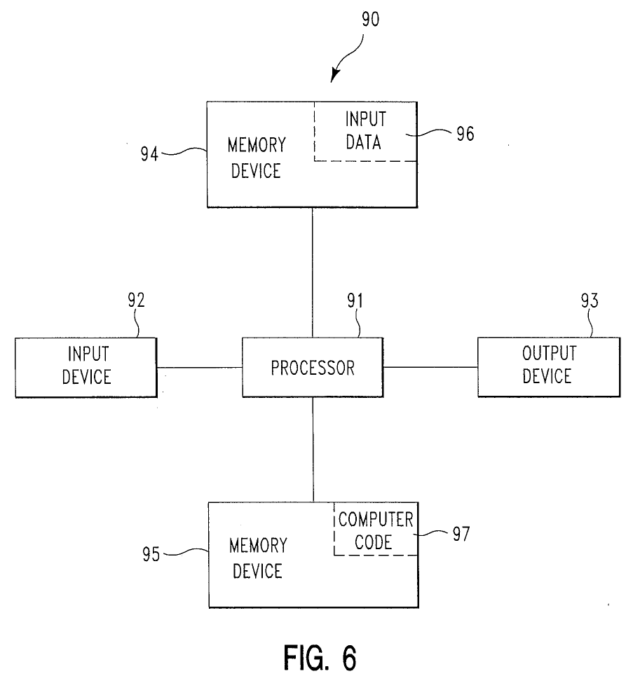

FIG. 6 illustrates a computer apparatus 90 (e.g., computing system 2 of FIG. 1) used for receiving information associated with a resource from a variety of sources and mapping the resource to a specific project based on the information, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., algorithms of FIGS. 2-5) receiving information associated with a resource from a variety of sources and mapping the resource to a specific project based on the information. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 6) may comprise the algorithms of FIGS. 2-5 and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise said computer usable medium (or said program storage device).

Still yet, any of the components of the present invention could be deployed, managed, serviced, etc. by a service provider who offers to receive information associated with a resource from a variety of sources and map the resource to a specific project based on the information.

Thus the present invention discloses a process for deploying or integrating computing infrastructure, comprising integrating computer-readable code into the computer system 90, wherein the code in combination with the computer system 90 is capable of performing a method receiving information associated with a resource from a variety of sources and mapping the resource to a specific project based on the information. In another embodiment, the invention provides a business method that performs the process steps of the invention on a subscription, advertising, and/or fee basis. That is, a service provider, such as a Solution Integrator, could offer receive information associated with a resource from a variety of sources and map the resource to a specific project based on the information. In this case, the service provider can create, maintain, support, etc., a computer infrastructure that performs the process steps of the invention for one or more customers. In return, the service provider can receive payment from the customer(s) under a subscription and/or fee agreement and/or the service provider can receive payment from the sale of advertising content to one or more third parties.

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A personnel management method comprising:
presenting to a first resource, by a computing system, a first survey comprising a first plurality of questions;
receiving, by said computing system, first data from said first resource in response to said first survey, said first data comprising first resource supplied information associated with: said first resource, a first management party associated with said first resource, and a first group of projects associated with said first resource;
presenting to said first management party, by said computing system, a second survey comprising a second plurality of questions;
receiving, by said computing system, second data from said first management party in response to said second survey, said second data comprising first management supplied information associated with said first resource, said first management party, and said first group of projects;
first analyzing, by said computing system, said first data with respect to said second data;
generating based on said first analyzing, by said computing system, a first resource specification report associated with said first resource;
generating based on said first analyzing, by said computing system, a first project model comprising first projected requirements for each project of said first group of projects; and
generating based on said first analyzing and said first project model, by said computing system, a first project specification report comprising first actual requirements for said first group of projects with respect to said first projected requirements for said first group of projects.

2. The method of claim 1, further comprising:
associating, by said computing system, said first resource with at least one project of said first group of projects, said associating based on information from said first resource specification report and said first project specification report.

3. The method of claim 1, further comprising:
presenting to a second resource, by said computing system, said first survey;
receiving, by said computing system, third data from said second resource in response to said first survey, said third data comprising second resource supplied information associated with: said second resource, a second management party associated with said second resource, and said first group of projects, said first group of projects additionally associated with said second resource;
presenting to said second management party, by said computing system, said second survey;
receiving, by said computing system, fourth data from said second management party in response to said second survey, said fourth data comprising second management supplied information associated with: said second resource, said second management party, and said first group of projects;
second analyzing, by said computing system, said third data with respect to said fourth data;
generating based on said second analyzing, by said computing system, a second resource specification report associated with said second resource;
generating based on said second analyzing, by said computing system, a second project model comprising second projected requirements for each project of said first group of projects; and
generating based on said second analyzing and said second project model, by said computing system, a second project specification report comprising second actual requirements for said first group of projects with respect to said second projected requirements for said first group of projects.

4. The method of claim 3, further comprising:
third analyzing, by said computing system, said first resource specification report and said first project specification report with respect to said second resource specification report and said second project specification report; and
selecting based on said third analyzing, by said computing system, said first resource or said second resource for performing duties associated with a first project of said first group of projects.

5. The method of claim 1, further comprising:
presenting to a customer associated with said first management party, by said computing system, a third survey comprising a third plurality of questions; and
receiving, by said computing system, third data from said customer in response to said third survey, said third data comprising customer supplied information associated with said first group of projects, wherein said generating said first project specification report is further based on said third data.

6. The method of claim 1, further comprising:
receiving, by said computing system, human resource based data from a user in a human resource department associated with said first group of projects, wherein said generating said first project specification report is further based on said human resource based data.

7. The method of claim 6, further comprising:
receiving, by said computing system, project management systems data, wherein said generating said first project specification report is further based on said project management systems data.

8. The method of claim 1, wherein portions of said first survey are presented to said first resource at different times.

9. The method of claim 1, further comprising:
second analyzing, by said computing system, said resource specification report and said project specification report; and
generating, by said computing system, a correlation report based on said second analyzing.

10. A computing system comprising a processor coupled to a computer-readable memory unit, said memory unit comprising instructions that when executed by the processor implement a personnel management method, said method comprising:
presenting to a first resource, by said computing system, a first survey comprising a first plurality of questions;
receiving, by said computing system, first data from said first resource in response to said first survey, said first data comprising first resource supplied information associated with: said first resource, a first management party associated with said first resource, and a first group of projects associated with said first resource;
presenting to said first management party, by said computing system, a second survey comprising a second plurality of questions;
receiving, by said computing system, second data from said first management party in response to said second survey, said second data comprising first management supplied information associated with said first resource, said first management party, and said first group of projects;
first analyzing, by said computing system, said first data with respect to said second data;
generating based on said first analyzing, by said computing system, a first resource specification report associated with said first resource;
generating based on said first analyzing, by said computing system, a first project model comprising first projected requirements for each project of said first group of projects; and
generating based on said first analyzing and said first project model, by said computing system, a first project specification report comprising first actual requirements for said first group of projects with respect to said first projected requirements for said first group of projects.

11. The computing system of claim 10, wherein said method further comprises:
associating, by said computing system, said first resource with at least one project of said first group of projects, said associating based on information from said first resource specification report and said first project specification report.

12. The computing system of claim 10, wherein said method further comprises:
presenting to a second resource, by said computing system, said first survey;
receiving, by said computing system, third data from said second resource in response to said first survey, said third data comprising second resource supplied information associated with:
said second resource, a second management party associated with said second resource, and said first group of projects, said first group of projects additionally associated with said second resource;
presenting to said second management party, by said computing system, said second survey;
receiving, by said computing system, fourth data from said second management party in response to said second survey, said fourth data comprising second management supplied information associated with: said second resource, said second management party, and said first group of projects;
second analyzing, by said computing system, said third data with respect to said fourth data;
generating based on said second analyzing, by said computing system, a second resource specification report associated with said second resource;
generating based on said second analyzing, by said computing system, a second project model comprising second projected requirements for each project of said first group of projects; and
generating based on said second analyzing and said second project model, by said computing system, a second project specification report comprising second actual requirements for said first group of projects with respect to said second projected requirements for said first group of projects.

13. The computing system of claim 12, wherein said method further comprises:
third analyzing, by said computing system, said first resource specification report and said first project specification report with respect to said second resource specification report and said second project specification report; and
selecting based on said third analyzing, by said computing system, said first resource or said second resource for performing duties associated with a first project of said first group of projects.

14. The computing system of claim 10, wherein said method further comprises:
presenting to a customer associated with said first management party, by said computing system, a third survey comprising a third plurality of questions; and
receiving, by said computing system, third data from said customer in response to said third survey, said third data comprising customer supplied information associated with said first group of projects, wherein said generating said first project specification report is further based on said third data.

15. The computing system of claim 10, wherein said method further comprises:
receiving, by said computing system, human resource based data from a user in a human resource department associated with said first group of projects, wherein said generating said first project specification report is further based on said human resource based data.

16. The computing system of claim 15, wherein said method further comprises:
receiving, by said computing system, project management systems data, wherein said generating said first project specification report is further based on said project management systems data.

17. The computing system of claim 10, wherein portions of said first survey are presented to said first resource at different times.

18. The computing system of claim 10, wherein said method further comprises:
second analyzing, by said computing system, said resource specification report and said project specification report; and
generating, by said computing system, a correlation report based on said second analyzing.

19. A process for supporting computer infrastructure, said process comprising providing at least one support service for at least one of creating, integrating, hosting, maintaining, and deploying computer-readable code in a computing system, wherein the code in combination with the computing system is capable of performing a personnel management method, said method comprising:
presenting to a first resource, by said computing system, a first survey comprising a first plurality of questions;
receiving, by said computing system, first data from said first resource in response to said first survey, said first data comprising first resource supplied information associated with: said first resource, a first management party associated with said first resource, and a first group of projects associated with said first resource;
presenting to said first management party, by said computing system, a second survey comprising a second plurality of questions;
receiving, by said computing system, second data from said first management party in response to said second survey, said second data comprising first management supplied information associated with said first resource, said first management party, and said first group of projects;
first analyzing, by said computing system, said first data with respect to said second data;
generating based on said first analyzing, by said computing system, a first resource specification report associated with said first resource;
generating based on said first analyzing, by said computing system, a first project model comprising first projected requirements for each project of said first group of projects; and
generating based on said first analyzing and said first project model, by said computing system, a first project specification report comprising first actual requirements for said first group of projects with respect to said first projected requirements for said first group of projects.

20. The process of claim 19, wherein said method further comprises:
associating, by said computing system, said first resource with at least one project of said first group of projects, said associating based on information from said first resource specification report and said first project specification report.

21. The process of claim 19, wherein said method further comprises:
presenting to a second resource, by said computing system, said first survey;
receiving, by said computing system, third data from said second resource in response to said first survey, said third data comprising second resource supplied information associated with: said second resource,sa second management party associated with said second resource, and said first group of projects, said first group of projects additionally associated with said second resource;
presenting to said second management party, by said computing system, said second survey;
receiving, by said computing system, fourth data from said second management party in response to said second survey, said fourth data comprising second management supplied information associated with: said second resource, said second management party, and said first group of projects;
second analyzing, by said computing system, said third data with respect to said fourth data;
generating based on said second analyzing, by said computing system, a second resource specification report associated with said second resource;
generating based on said second analyzing, by said computing system, a second project model comprising second projected requirements for each project of said first group of projects; and
generating based on said second analyzing and said second project model, by said computing system, a second project specification report comprising second actual requirements for said first group of projects with respect to said second projected requirements for said first group of projects.

22. The process of claim 21, wherein said method further comprises:
third analyzing, by said computing system, said first resource specification report and said first project specification report with respect to said second resource specification report and said second project specification report; and
selecting based on said third analyzing, by said computing system, said first resource or said second resource for performing duties associated with a first project of said first group of projects.

23. The process of claim 19, wherein said method further comprises:
presenting to a customer associated with said first management party, by said computing system, a third survey comprising a third plurality of questions; and
receiving, by said computing system, third data from said customer in response to said third survey, said third data comprising customer supplied information associated with said first group of projects, wherein said generating said first project specification report is further based on said third data.

24. The process of claim 19, wherein said method further comprises:
receiving, by said computing system, human resource based data from a user in a human resource department associated with said first group of projects, wherein said generating said first project specification report is further based on said human resource based data.

25. The process of claim 24, wherein said method further comprises:
receiving, by said computing system, project management systems data, wherein said generating said first project specification report is further based on said project management systems data.

26. The process of claim 19, wherein portions of said first survey are presented to said first resource at different times.

27. The process of claim 19, wherein said method further comprises:
second analyzing, by said computing system, said resource specification report and said project specification report; and generating, by said computing system, a correlation report based on said second analyzing.

28. A computer program product, comprising a computer usable medium comprising a computer readable program code embodied therein, said computer readable program code adapted to implement a personnel management method within a computing system, said method comprising:
presenting to a first resource, by said computing system, a first survey comprising a first plurality of questions;
receiving, by said computing system, first data from said first resource in response to said first survey, said first data comprising first resource supplied information associated with: said first resource, a first management party associated with said first resource, and a first group of projects associated with said first resource;
presenting to said first management party, by said computing system, a second survey comprising a second plurality of questions;
receiving, by said computing system, second data from said first management party in response to said second survey, said second data comprising first management supplied information associated with said first resource, said first management party, and said first group of projects;
first analyzing, by said computing system, said first data with respect to said second data;
generating based on said first analyzing, by said computing system, a first resource specification report associated with said first resource;
generating based on said first analyzing, by said computing system, a first project model comprising first projected requirements for each project of said first group of projects; and
generating based on said first analyzing and said first project model, by said computing system, a first project specification report comprising first actual requirements for said first group of projects with respect to said first projected requirements for said first group of projects.

29. The computer program product of claim 28, wherein said method further comprises:
associating, by said computing system, said first resource with at least one project of said first group of projects, said associating based on information from said first resource specification report and said first project specification report.

30. The computer program product of claim 28, wherein said method further comprises:
presenting to a second resource, by said computing system, said first survey;
receiving, by said computing system, third data from said second resource in response to said first survey, said third data comprising second resource supplied information associated with: said second resource, a second management party associated with said second resource, and said first group of projects, said first group of projects additionally associated with said second resource;
presenting to said second management party, by said computing system, said second survey;
receiving, by said computing system, fourth data from said second management party in response to said second survey, said fourth data comprising second management supplied information associated with: said second resource, said second management party, and said first group of projects;
second analyzing, by said computing system, said third data with respect to said fourth data;
generating based on said second analyzing, by said computing system, a second resource specification report associated with said second resource;
generating based on said second analyzing, by said computing system, a second project model comprising second projected requirements for each project of said first group of projects; and
generating based on said second analyzing and said second project model, by said computing system, a second project specification report comprising second actual requirements for said first group of projects with respect to said second projected requirements for said first group of projects.

31. The computer program product of claim 30, wherein said method further comprises:
third analyzing, by said computing system, said first resource specification report and said first project specification report with respect to said second resource specification report and said second project specification report; and
selecting based on said third analyzing, by said computing system, said first resource or said second resource for performing duties associated with a first project of said first group of projects.

32. The computer program product of claim 28, wherein said method further comprises:
presenting to a customer associated with said first management party, by said computing system, a third survey comprising a third plurality of questions; and
receiving, by said computing system, third data from said customer in response to said third survey, said third data comprising customer supplied information associated with said first group of projects, wherein said generating said first project specification report is further based on said third data.

33. The computer program product of claim 28, wherein said method further comprises:
receiving, by said computing system, human resource based data from a user in a human resource department associated with said first group of projects, wherein said generating said first project specification report is further based on said human resource based data.

34. The computer program product of claim 33, wherein said method further comprises:
receiving, by said computing system, project management systems data, wherein said generating said first project specification report is further based on said project management systems data.

35. The computer program product of claim 28, wherein portions of said first survey are presented to said first resource at different times.

36. The computer program product of claim 28, wherein said method further comprises:
second analyzing, by said computing system, said resource specification report and said project specification report; and
generating, by said computing system, a correlation report based on said second analyzing.
